(19) United States
(12) Patent Application Publication
(10) Pub. No.: US 2002/0183873 A1
(43) Pub. Date: Dec. 5, 2002

(54) Recording device, reproducing device and recording/reproducing system

(76) Inventors: Haruyuki Miura, Tokyo (JP); Takashi Koya, Tokyo (JP); Ryohei Yasuda, Tokyo (JP); Hajime Kanno, Tokyo (JP)

Correspondence Address: Jay H Maioli, Cooper & Dunham, 1185 Avenue of the Americas, New York, NY, 10036, US

(21) Appl. No.: 10/088,705

(22) PCT Filed: Jul. 13, 2001
(86) PCT No.: PCT/JP01/06093

(30) Foreign Application Priority Data
Jul. 21, 2000 (JP) 2000-2204940
Aug. 30, 2000 (JP) 2000-261601

(51) Int. Cl. G06F 17/00; G11B 7/0045; G11B 7/28

(52) U.S. Cl. 700/94; 710/15; 369/47.12

(57) ABSTRACT

The present invention is capable of dubbing again even when a data transfer error occurs, because the dubbing is tried again by sending a command to reproduce to the optical disc reproducing apparatus 1 from the magneto-optical disc recording/plying system 3 after completing the reproducing retry preparation and recording retry preparation.

### TECHNICAL FIELD

The present invention relates to recording apparatus, reproducing apparatus, and recording/reproducing system which, for example, reproduce audio data recorded in an optical disc and dub the audio data in a magneto-optical disc through an interface which is in conformity to IEEE 1394 format.

### BACKGROUND ART

Recently, as a magneto-optical disc used for magneto-optical recording such as, for example, a mini-disc, disc-like recording media which are capable of recording and reproducing audio data and recording/reproducing apparatuses which operate recording and reproducing of audio data in and from such disc-like recording media have come into wide use.

Additionally, audio systems which combine an MD recorder/player which records and reproduces audio data in and from such magneto-optical discs as, for example, mini-discs (MD) with a CD player which operates reproducing of audio data in optical discs (CD) used only for reproducing have also come into wide use.

Generally, audio systems like those described above are constructed such that so-called dubbing in which audio data reproduced by a CD player are recorded in an mini-disc (MD) by an MD recorder/player can be performed.

There also exists an audio system which uses an interface which is in conformity to the IEEE 1394 format as a data transfer method in said dubbing.

Conventionally, for example, in a dubbing device which dubs audio data from a CD player to an MD recorder/player, noise and a sound skipping state which indicates a discontinuity between played audio signals generated by dusts and scratch on the surface of an optical disc reproduced by the CD player and vibration and the like of the optical disc were recorded in the MD recorder/player as they were.

For problems described above, while reading out audio data from recording media such as optical disc by CD player, factors used to judge generations of noise and/or discontinuity between reproduced audio signals have been supervised, for example, by correcting errors in the course of reproduction.

By doing so, when noise or sound skipping which indicates discontinuity between audio signals occurs, there have existed audio systems in which, by changing conditions for the dubbing, high quality audio data can be secured as a result of recording or dubbing by an MD recorder/player.

In this case, when the above described error occurred in a normal reproduction mode, reproducing was performed again by returning back to the head portion of the reproduced music. Further, when the above described error occurred at the time of a programmed reproducing mode in which pieces of music are reproduced in previously programmed order, reproducing was performed again by returning back to the head portion of the first music piece reproduced as programmed. Furthermore, when the above described error occurred at the time of a shuffle reproducing mode in which reproducing is performed in arbitrary order by shuffling music to be reproduced, the order of shuffled music was cleared once, and therefore, reproducing was performed again by returning back to the head portion of the first music piece reproduced under the normal reproducing mode.

As described above, however, in the conventional audio systems, only dubbing conditions were changed by detecting an error during reproducing music by CD players, and for this reason, there was such an inconvenience that sound quality of dubbed audio signals could not be improved in case of such an error as noise or sound skipping which indicated discontinuity of reproduced audio signals is generated during transfer.

Particularly, when above described error occurred at the time of a normal reproducing mode, reproducing was performed again after returning back to the head portion of reproduced music, and for this reason, there was such inconvenience that same music at the time of normal reproducing was recorded in a plural number of times repeatedly. Also, when above described error occurred at the time of a programmed reproducing mode in which reproducing was performed in previously programmed order, reproducing was repeated by returning back to the first music piece reproduced as programmed. Therefore the same music at the time of programmed reproducing was recorded a plural number of times repeatedly. In addition, when above described error occurred at the time of a shuffle reproducing mode in which reproducing was performed in arbitrary order by shuffling music to be reproduced, the order of shuffled music was cleared once, reproducing was performed again by returning back to the head portion of the music reproduced under a normal reproducing mode, and for this reason, there was such inconvenience that the same music was recorded a plural number of times repeatedly at the time of shuffle reproducing before the occurrence of the error and at the time of normal reproducing after the occurrence of the error, or furthermore, a piece of music which could not be recorded at the time of shuffle reproducing before the occurrence of the error also could not be recorded at the time of normal reproducing after the occurrence of the error, causing such inconvenience that the music unexpected to the user is recorded.

### DISCLOSURE OF THE INVENTION

The present invention has been made with the above described points taken into consideration, and it is an object of the present invention to provide a recording apparatus, reproducing apparatus, and recording/reproducing system which are capable of improving sound quality of dubbed audio signals even when an error occurs during data transfer.

In order to solve such problems, the recording apparatus of the present invention dubs data reproduced by a reproducing unit and transferred by an interface unit in a predetermined format, comprising, transfer error detection means that detects an error of data transfer occurred in the interface unit, transfer error notification means that notifies the transfer error to the reproducing unit, recording retry preparation means that stops the data transfer based on the notification of the error after returning back to the start of the track of the data in which the transfer error occurred, and retry means that sends a command to reproduce to the reproducing unit after completing preparation of the recording retry so that dubbing is tried again.

Further, the reproducing apparatus of the present invention transfers reproduced data to the recording unit in a designated format by the interface unit and reproduces data to dub them in the recording unit comprising, transfer error receiving means that receives data transfer error notification in the interface unit detected by the recording unit, reproducing retry prepararation means that stops the data transfer based on the error notification after returning back to the start of the track of the data on which the transfer error occurred, and retry means that receives a command to reproduce from the recording unit after completing preparation of the reproducing retry so that dubbing is tried again.

Furthermore, the recording/reproducing system of the present invention is applied to a recording/reproducing system that dubs data by employing a reproducing unit that reproduces data, a recording unit that records the reproduced data, and an interface unit that transfers data in a predetermined format between the reproducing unit and recording unit.

The recording/reproducing system of the present invention, in particular, comprising transfer error detection means that detects a data transfer error in the interface unit, transfer error notification means that notifies a transfer error from the recording unit to the reproducing unit, reproducing retry preparation means that causes the reproducing unit based on the error notification to stop after returning back to the start of the track of the data on which the transfer error occurred, recording retry preparation means that causes the recording unit based on the error notification to stop after returning back to the start of the track of the data on which the transfer error occurred, and retry means that sends a command to reproduce from the recording unit to the reproducing unit after completing the reproducing retry preparation at the reproducing unit and retries dubbing.

In the recording/reproducing system of the present invention, the following operation is performed.

A controller in the recording unit is notified that an error has occurred in a data transfer from the interface unit through a bus, stops the operation, and sends an error notification to a controller in the reproducing unit. The controller in the reproducing unit moves to a retry mode, and stops the operation. On receiving error notification, the reproducing unit is caused to stop under the retry mode. Upon completion of retry preparation, the recording unit sends a command to reproduce to the reproducing unit. Upon receiving of the command to reproduce, the reproducing unit starts reproducing after returning back to the start of the track on which the error has occurred, and the recording unit starts recording from the start of the track, and thus, dubbing is tried again.

Further, the recording/reproducing system of the present invention has, in particular, transfer error detection means that detects a data transfer error in the interface unit and stop means that stops dubbing when a transfer error is detected during a dubbing.

In the recording/reproducing system of the present invention, the following operation is performed.

The controller in the recording unit is notified that an error has occurred in a data transfer through the bus from the interface unit, stops the operation, and sends an error notification to the controller in the reproducing unit. The controller in the reproducing unit moves to the stop mode, and stops the operation.

### BRIEF DESCRIPTION OF THE DRAWINGS

FIG. 1 is a diagram illustrating configuration of the dubbing retry device according to an embodiment of the present invention.

FIG. 2 is a diagram illustrating configuration of the optical disc reproducing apparatus.

FIG. 3 is a diagram illustrating configuration of the magneto-optical disc recording/reproducing apparatus.

FIG. 4 is a sequence diagram showing commands sent and received up to a retry.

FIG. 5 is a diagram illustrating a state under which the optical disc reproducing apparatus normally reproduced and dubbing was performed normally on the magneto-optical disc recording/reproducing apparatus without a transfer error, wherein FIG. 5A shows order of music reproduced by the optical disc reproducing apparatus, and FIG. 5B shows order of music recorded by the magneto-optical disc recording/reproducing apparatus.

FIG. 6 is a diagram illustrating a state under which the optical disc reproducing apparatus normally reproduced, a transfer error occurred in the middle of the second music, and dubbing was performed on the magneto-optical disc recording/reproducing apparatus from the start of the second music, wherein FIG. 6A shows order of music reproduced by the optical disc reproducing apparatus, and FIG. 6B shows order of music recorded by the magneto-optical disc recording/reproducing apparatus.

FIG. 7 is a diagram illustrating a state under which the optical disc reproducing apparatus reproduced music in a programmed order, a transfer error occurred in the middle of the second music, and dubbing was performed on the magneto-optical disc recording/reproducing apparatus from the start of the second music, wherein FIG. 7A shows order of music reproduced by the optical disc reproducing apparatus, and FIG. 7B shows order of music recorded by the magneto-optical disc recording/reproducing apparatus.

FIG. 8 is a flow chart showing an operation of detecting error under a PLL unlocked condition.

FIG. 9 is a flow chart showing an operation of detecting an error with the number of receipt of empty packets.

FIG. 10 is a flow chart showing an operation of detecting an error with a receipt of audio signals other than IEC 958 format.

FIG. 11 is a flow chart showing an operation of detecting an error with an insufficiency of isochronous resource.

FIG. 12 is a flow chart showing an operation of detecting an error with an occurrence of bus reset.

FIG. 13 is a flow chart showing an operation of detecting an error with a reproduction prohibited copy right data.

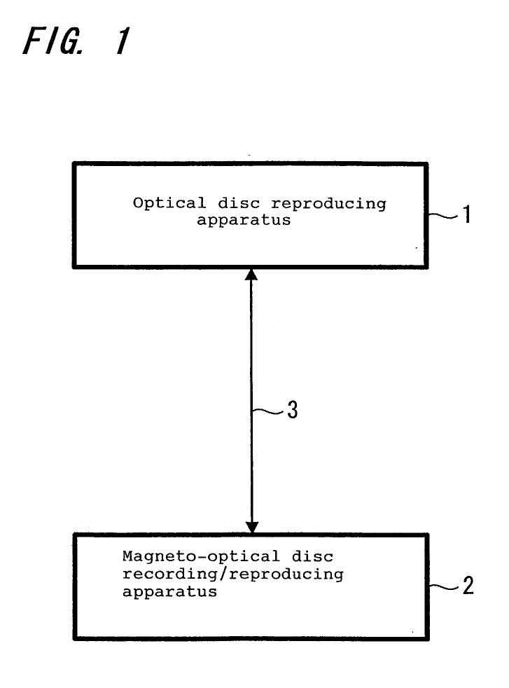

### BEST MODE FOR CARRYING OUT THE INVENTION

The recording/reproducing system of the preferred embodiment of the present invention will be described in detail with reference to the accompanying drawings as required. In the following details, as a dubbing retry device applied to this preferred embodiment, an example in which an optical disc reproducing apparatus 1 and a magneto-optical disc recording/reproducing apparatus 2 are connected with an IEEE 1394 bus 3 which is an interface in conformity to the IEEE 1394 format will be described.

This dubbing retry device transfers data reproduced by the optical disc reproducing apparatus 1 to the magneto-optical disc recording/reproducing apparatus 2 through the IEEE 1394 bus 3, and retries the dubbing when a transfer error occurs due to the IEEE 1394 bus 3 at the time of dubbing by the magneto-optical disc recording/reproducing apparatus 2. And herein, an example in which a compact disc (CD) is used as the recording media in the optical disc reproducing apparatus 1 and a mini-disc (MD) is used as the recording media in the magneto-optical recording/reproducing apparatus 2 will be described.

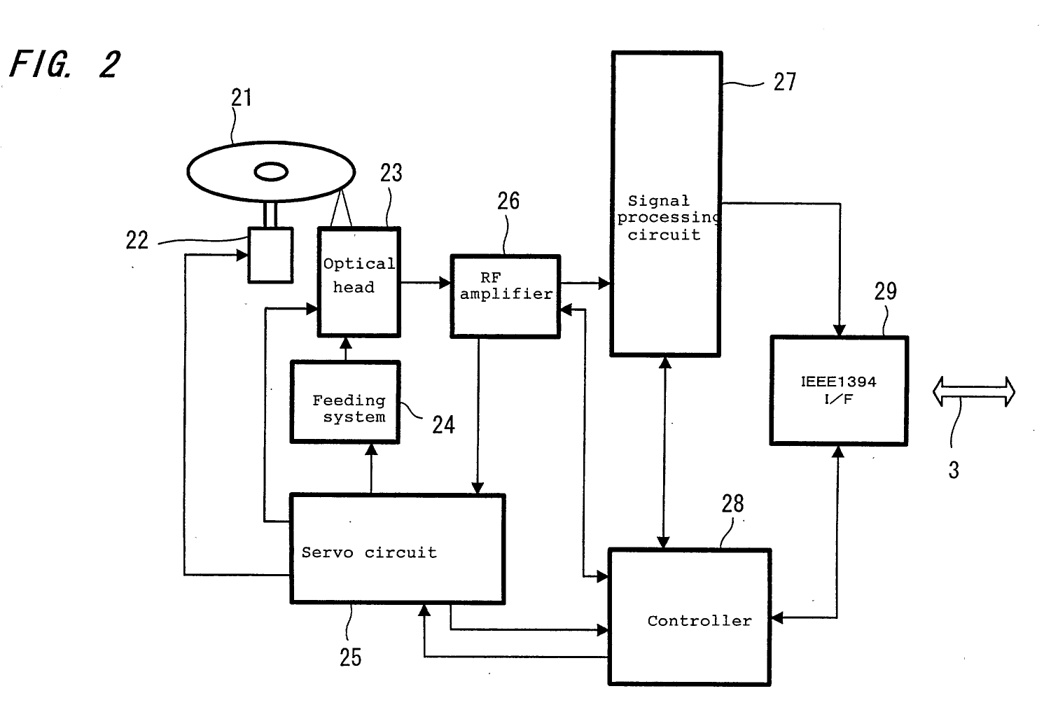

Referring to FIG. 2, the optical disc reproducing apparatus 1 of the preferred embodiment is comprised of an optical disc 21 in which audio data are recorded, a spindle motor 22 that turns and drives the optical disc 21, an optical head 23 that irradiates a laser beam to the optical disc 21 for reproducing, a feeding system 24 that transports the optical head 23 toward a radius direction of the optical disc 21, an RF amplifier 26 that detects light reflected from the optical disc 21 out of the laser beams irradiated by the optical head 23, and generates RF signals, focus servo signals, tracking servo signals and spindle servo signals, by adding or subtracting and amplifying the reflected light so that signals can be processed in the latter step, and a servo circuit 25 that actuates a focus coil and a tracking coil of a biaxial actuator of the optical head 23 based on the focus servo signal, tracking servo signal and spindle servo signal generated by the RF amplifier 26, transports the optical head 23 toward the radius direction of the optical disc 21 by the feeding system 24 and actuates the spindle motor 22.

The optical disc reproducing apparatus 1 of the preferred embodiment is comprised of a signal processing circuit 27 that extracts clock signals from RF signals generated by the RF amplifier 26 and performs such processing as EFM (8-14 modulation) decoding, correction of an error, interpolation, and sub-code decoding on the RF signals, and an IEEE 1394 interface (I/F) circuit 29 that writes or reads data the signals of which have been processed by the signal processing circuit 27 into or from a buffer, stores the data in the buffer once, and thereafter transfers the data in the IEEE 1394 format at a predetermined rate.

Further, the optical disc reproducing apparatus of the preferred embodiment comprised of a controller 28 that generates clock signals with frequencies of reproduced RF signals sent from the RF amplifier 26, supplies clock signals to the signal processing circuit 27 and the IEEE 1394 interface circuit 29, and further supplies control signals to the servo circuit 25, the signal processing circuit 27 and the IEEE 1394 interface circuit 29 to control operations of these circuits.

Operations of the optical disc reproducing apparatus of the preferred embodiment configured as described above will be described.

Referring to FIG. 2, signals recorded in the optical disc 21 are read out by irradiating laser beams from the optical head 23, and become so called RF signals after passing through the RF amplifier 26. The RF signals receive such processing as an EFM decoding, correction of an error, interpolation, and sub-code decoding, and the main data (audio data) output is stored in the buffer within the IEEE 1394 interface circuit 29.

The audio data stored in the buffer within the IEEE 1394 interface circuit 29 are read out by the controller 28 at a predetermined rate, and become audio output in the IEEE 1394 format.

Moreover, in the above described preferred embodiment, a CD was indicated as an example of the optical disc 1, however, as a recording medium to be reproduced, other optical discs, for example, a mini disc (MD), digital versatile disc (DVD), rewritable type CD-R, or magneto-optical disc (MO) may also be used.

The recording/reproducing apparatus of the preferred embodiment will be described as follows in detail with reference to the accompanying drawings as required. In this preferred embodiment, the recording/reproducing apparatus uses a mini disc (MD) among the magneto-optical discs as a recording medium.

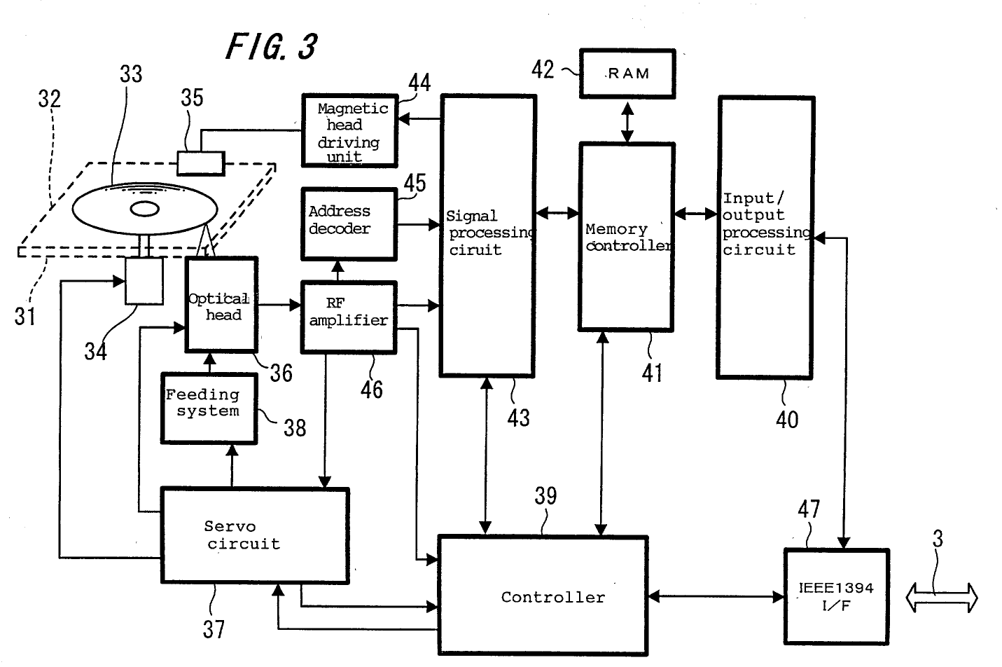

Referring to FIG. 3, the recording/reproducing apparatus of the preferred embodiment is comprised of a mini disc 31 in which audio data are recorded, a jacket 32 with a shutter, a magneto-optical disc 33 in which data are magneto-optically recorded in a mini disc format, a spindle motor 34 which turns and drives the magneto-optical disc 33, an optical head 36 that irradiates laser beams for recording or reproducing audio data to the magneto-optical disc 33 through an object lens, a magnetic head actuating unit 44 that generates signals to modulate magnetic field with recorded data at the time of a recording, a magnetic head 35 that applies modulated magnetic field to the magneto-optical disc, an RF amplifier 46 that detects light reflected from the magneto-optical disc 33 out of the laser beams irradiated by the optical head 36, and generates RF signals, focus servo signals, tracking servo signals and spindle servo signals, by adding or subtracting and amplifying the reflected light so that signals can be processed in the latter step, a feeding system 38 that transports the optical head 36 toward the radius direction of the magneto-optical disc 33, and a servo circuit 37 that generates various servo actuating signals based on the focus servo signals, tracking servo signals and spindle servo signals generated by the RF amplifier 46, causes a focus coil and a tracking coil of a biaxial actuator of the optical head 36 and the feeding system 38 to actuate, and causes the spindle motor 34 to actuate.

Further, the magneto-optical recording/reproducing apparatus of the preferred embodiment is comprised of an address decoder 45 that extracts clock signals from the RF signals generated by the RF amplifier 46 and decodes address signals, a signal processing circuit 43 that performs EFM (8-14 modulation) encoding and decoding, and encode processing and decode processing of CIRC (Cross Interleave Reed-Solomon Code) on the RF signals, a memory controller 41 that controls writing or reading of data the signals of which are processed by the signal processing circuit 43 for a buffer RAM 42, a buffer RAM 42 used to read out reproduced data at a predetermined rate after storing once in a memory.

Further, the magneto-optical recording/reproducing apparatus of the preferred embodiment is comprised of an input/output processing circuit 40 that compresses input data with a predetermined ratio by making a sub-band coding coordinated with the perception process of a human being by means of an ATRAC (Adaptive Transform Acoustic Coding) method in the recording system and expands the data read out from the buffer RAM 42 to a predetermined ratio in the reproducing system, and an IEEE 1394 interface (I/F) 47 that writes or reads data the signals of which are processed by the input/output processing circuit 40 into or out from the buffer and transfers the data in the IEEE 1394 format at a predetermined rate after storing the data once in the buffer memory.

Further, the recording/reproducing apparatus of the preferred embodiment is comprised of a controller 39 that supplies control signals to the servo circuit 37, signal processing circuit 43, memory control circuit 41 and IEEE 1394 interface (I/F) circuit 47, and controls operations of the circuits.

Operations of thus composed recording/reproducing apparatus of the preferred embodiment will be described as follows.

First, operation at the time of reproducing will be described.

Referring to FIG. 3, signals recorded in the magneto-optical disc 33 are read out by irradiating laser beams with reading power from the optical head 36, and become what is called RF signals through the RF amplifier 46. The RF signals receive such processing as EFM decoding, error correction and the like by the signal processing circuit 43, and the main data (audio data) output is stored in the buffer RAM 42 through the memory controller 41.

The audio data stored in the buffer RAM 42 are read out again at the normal reproducing rate by the memory controller 41, and the audio output is expanded by the input/output processing circuit 40, and the expanded audio output is stored in the buffer within the IEEE 1394 interface circuit 47.

The audio data stored in the buffer within the IEEE 1394 interface circuit 47 are read out by the controller 39 at a predetermined transfer rate, and become audio output in the IEEE 1394 format.

Next, operation at the time of recording will be described. This operation is the dubbing (recording) operation of the preferred embodiment.

When audio data in the IEEE 1394 format are input from the IEEE 1394 bus 3 to the IEEE 1394 interface circuit 47, the audio data are stored in the buffer within the IEEE 1394 interface circuit 47, read out at a predetermined transfer rate, compressed by the input/output processing circuit 40, stored once in the buffer RAM 42 by the memory controller 41, and the audio data are read out again by the memory controller 41 at a predetermined recording rate.

The audio data, read out from the buffer RAM 42 through the memory controller 41 receive such processing as EFM encoding, error correction and the like by the signal processing circuit 43, and are magnetically modulated by the magnetic head actuating unit 44 based on the main data (audio data), and are magneto-optically recorded by the magnetic head 35 into the magneto-optical disc 33 irradiated with a laser beam having writing power from the optical head 36. Note that the laser beam with writing power is a comparatively high level laser output used to heat the recording track up to Curie temperature.

Further, in the above described preferred embodiment, an MD is used as an example for the magneto-optical disc 33, however, other optical discs such as, for example, a digital versatile disc (DVD), rewritable type CD-R and magneto-optical disc (MO) may also be used as a recording medium in which data can be recorded.

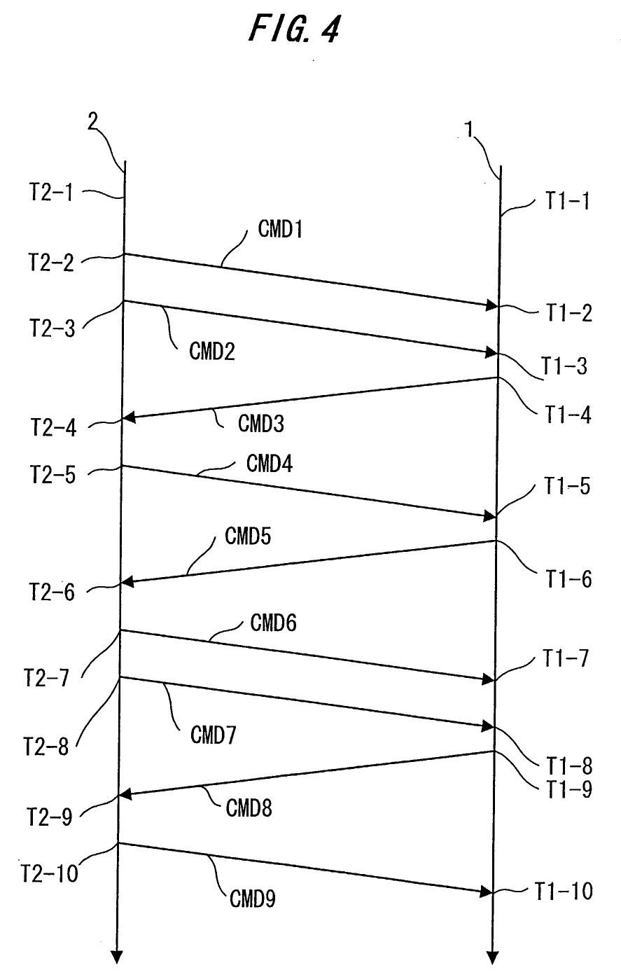

Next, referring to the sequence diagram of FIG. 4, command exchanges at a dubbing retry in this preferred embodiment will be described. FIG. 4 indicates the dubbing retry sequence when the magneto-optical disc recording/reproducing apparatus 2 decides that a transfer error has occurred during a dubbing from the optical disc reproducing apparatus 1 to the magneto-optical disc recording/reproducing apparatus 2 through the IEEE 1394 bus 3.

In FIG. 4, on the vertical axes (time axes), operation sequence of the optical disc reproducing apparatus 1 and that of the magneto-optical disc recording/reproducing apparatus 2 are indicated, and arrows in both directions indicate command exchange between the optical disc reproducing apparatus 1 and magneto-optical disc recording/reproducing apparatus 2.

In FIG. 4, the optical disc reproducing apparatus 1 performs reproducing at the time of T1-1, and magneto-optical disc recording/reproducing apparatus 2 performs recording at the time of T2-1. Specifically, audio data reproduced by the optical disc reproducing apparatus 1 are transferred to the magneto-optical disc recording/reproducing apparatus 2 through the IEEE 1394 bus 3, and are dubbed by the magneto-optical disc recording/reproducing apparatus 2.

The magneto-optical disc recording/reproducing apparatus 2 detects an error at the time of T2-2, stops the operation, and sends the error notifying command CMD1 to the optical disc reproducing apparatus 1. The optical disc reproducing apparatus 1 enters a retry mode at the time of T1-2, and stops the operation.

Specifically, the controller 39 of the magneto-optical disc recording/reproducing apparatus 2 is notified that an error has occurred on data transfer from the IEEE 1394 interface circuit 47 through the IEEE 1394 bus 3, stops the operation, and sends an error notifying command CMD1 to the controller 28 of the optical disc reproducing apparatus 1. The controller 28 of the optical disc reproducing apparatus 1 moves to the retry mode by receiving the error notifying command CMD1, and stops the operation.

The magneto-optical disc recording/reproducing apparatus 2 sends, at the time of T2-3, a reproducing status requesting command CMD2 to the optical disc reproducing apparatus 1. The optical disc reproducing apparatus 1 receives the status requesting command CMD2 at the time of T1-3, and sends a [STOP] status notifying command CMD3 to the magneto-optical disc recording/reproducing apparatus 2 at the time of T1-4. The magneto-optical disc recording/reproducing apparatus 2 receives the [STOP] status notifying command CMD3 at the time of T2-4. Further, the time of 2-2 and 2-3 may occur concurrently.

Specifically, the controller 39 of the magneto-optical disc recording/reproducing apparatus 2 sends the status requesting command CMD2 to the controller 28 of the optical disc reproducing apparatus 1. Since the controller 28 of the optical disc reproducing apparatus 1 has recognized the [STOP] status, it returns the [STOP] status notifying command CMD3 to the controller 39 of the magneto-optical disc recording/reproducing apparatus 2.

The magneto-optical recording/reproducing apparatus 2 sends, at the time of T2-5, a retry condition requesting command CMD4 to the optical disc reproducing apparatus 1. The optical disc reproducing apparatus 1 receives the retry condition requesting command CMD4 at the time of T1-5, and sends a retry condition notifying command CMD5 to send back conditions such as velocity at the time of the retry from the optical disc reproducing apparatus 1 to the magneto-optical disc recording/reproducing apparatus 2 at the time of T1-6. The magneto-optical disc recording/reproducing apparatus 2 receives the retry condition notifying command CMD5 at the time of T2-6, and erases the track on which the error occurred.

Specifically, the controller 39 of the magneto-optical disc recording/reproducing apparatus 2 sends the retry condition requesting command CMD4 to the controller 28 of the optical disc reproducing apparatus 1. Since the controller 28 of the optical disc reproducing apparatus 1 has recognized the conditions such as velocity at the time of the retry by means of a parameter or the like predetermined according to the error, the controller 28 of the optical disc reproducing apparatus 1 returns the retry condition notifying command CMD5 to the controller 39 of the magneto-optical disc recording/reproducing apparatus 2. The controller 39 of the magneto-optical disc recording/reproducing apparatus 2 receives the retry condition notifying command CMD5, and under the erase mode erases the track on which the error occurred in accordance with the retry condition notifying command CMD5.

The magneto-optical disc recording/reproducing apparatus 2 stands in readiness after moving to the status of [Pause] (REC PAUSE) which is a standby for recording operations with the retry condition notifying command CMD5 at the time of T2-7, and sends a command CMD6 of [Pause] to the optical disc reproducing apparatus 1. With the command CMD6 of [Pause], the optical disc reproducing apparatus 1 returns to the start of the track to be retried at the time of T1-7, and stands in readiness after moving to the status of [Pause] (PAUSE) which is a standby for reproducing operations.

Specifically, the controller 39 of the magneto-optical disc recording/reproducing apparatus 2 starts various servo operations and stands in readiness after moving to the status of [Pause] (REC PAUSE) which is a standby for recording operations, and the controller 28 of the optical disc reproducing apparatus 1 starts various servo operations and stands in readiness after moving to the status of [Pause] (PAUSE) which is a standby for reproducing operations.

The magneto-optical disc recording/reproducing apparatus 2 sends a status requesting command CMD7 to the optical disc reproducing apparatus 1 at the time of T2-8. The optical disc reproducing apparatus 1 receives the status requesting command CMD7 at the time of T1-8, and at the time of T1-9, the optical disc reproducing apparatus 1 sends a [Pause] status notifying command CMD8 to the magneto-optical recording/reproducing system 2. The magneto-optical disc recording/reproducing apparatus 2 receives the [Pause] status notifying command CMD8 at the time of T2-9. Further, the time of 2-7 and T2-8 may occur concurrently.

Specifically, the controller 39 of the magneto-optical recording/reproducing system 2 sends the status requesting command CMD7 to the controller 28 of the optical disc reproducing apparatus 1. Since the controller 28 of the optical disc reproducing apparatus 1 has recognized the [Pause] status, the controller 28 returns the [Pause] status command CMD8 to the controller 39 of the magneto-optical disc recording/reproducing apparatus 2.

The magneto-optical disc recording/reproducing apparatus 2 starts recording at the time of T2-10, and sends a command to reproduce CMD9 to the optical disc reproducing apparatus 1. The optical disc reproducing apparatus 1 starts reproducing at the time of T1-10. Further, the time of T2-9 and T2-10 may occur concurrently.

Specifically, the controller 39 of the magneto-optical disc recording/reproducing apparatus 2 starts recording operations, and sends the command to reproduce CMD9 to the controller 28 of the optical disc reproducing apparatus 1. The controller 28 of the optical disc reproducing apparatus 1 starts reproducing operations.

FIG. 5 shows the status under which the optical disc reproducing apparatus 1 reproduced music in the normal order, and the reproduced music were dubbed normally in the magneto-optical disc recording/ reproducing apparatus 2 without any transfer error.

In FIG. 5A, music is reproduced by the optical disc reproducing apparatus 1 in such normal order as 1st music (P1), 2nd music (P2), 3rd music (P3), 4th music (P4), and 5th music (P5).

In FIG. 5B, without any transfer error, music recorded by the magneto-optical recording/reproducing apparatus 2 is dubbed (recorded) as indicated by 51 in such normal order as 1st music (R1), 2nd music (R2), 3rd music (R3), 4th music (R4), and 5th music (R5).

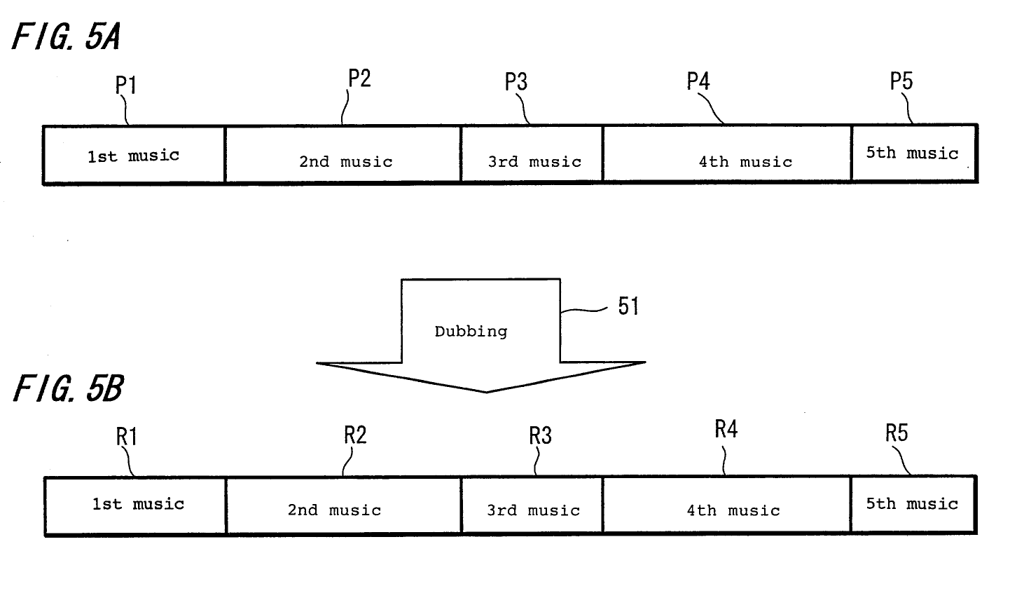

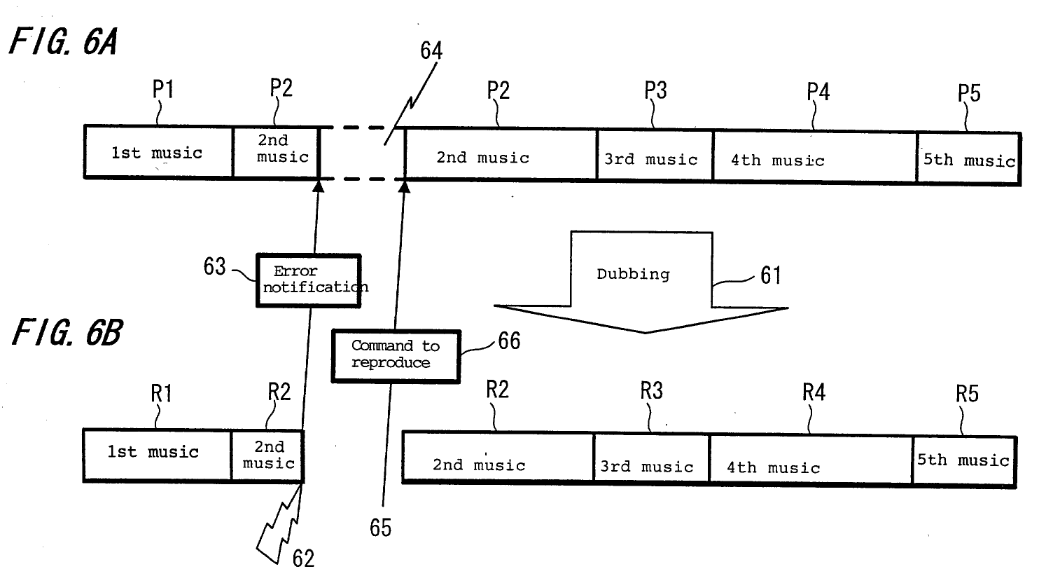

FIG. 6 indicates that the optical disc reproducing apparatus 1 reproduced music in the normal order, and a transfer error occurred in the middle of the 2nd music, and dubbing was performed from the beginning of the 2nd music in the magneto-optical disc recording/ reproducing apparatus 2.

In FIG. 6A, the optical disc reproducing apparatus 1 reproduced music in order of 1st music (P1) and 2nd music (P2), and as shown in FIG. 6B, a transfer error occurred in the middle of the 2nd music when dubbing 61 was being performed in such music recording order of the 1st music (R1) and 2nd music (R2) in the magneto-optical recording/reproducing apparatus 2.

At this time, the magneto-optical disc recording/reproducing apparatus 2 detects the error as indicated by 62, and notifies the error to the optical disc reproducing apparatus 1 as indicated by 63. Upon receiving an error notification 63, the optical disc reproducing apparatus 1 is placed under a stop status 64 in a retry mode. The magneto-optical disc recording/reproducing apparatus 2 sends a reproducing command 66 to the optical disc reproducing apparatus 1 at the time 65 when a retry preparation is completed. upon receiving the reproducing command 66, the optical disc reproducing apparatus 1 returns to the start of the 2nd music (P2) on which the error occurred and starts reproducing, and the magneto-optical disc recording/reproducing apparatus 2 starts recording from the start of the 2nd music (R2).

Thereafter, the optical disc reproducing apparatus 1 reproduces music in order of 2nd music (P2), 3rd music (P3), 4th music (P4), and 5th music (P5), and the magneto-optical disc recording/ reproducing apparatus 2 performs the dubbing 61 in order of 2nd music (R2), 3rd music (R3), 4th music (R4), and 5th music (R5) as shown in FIG. 6B.

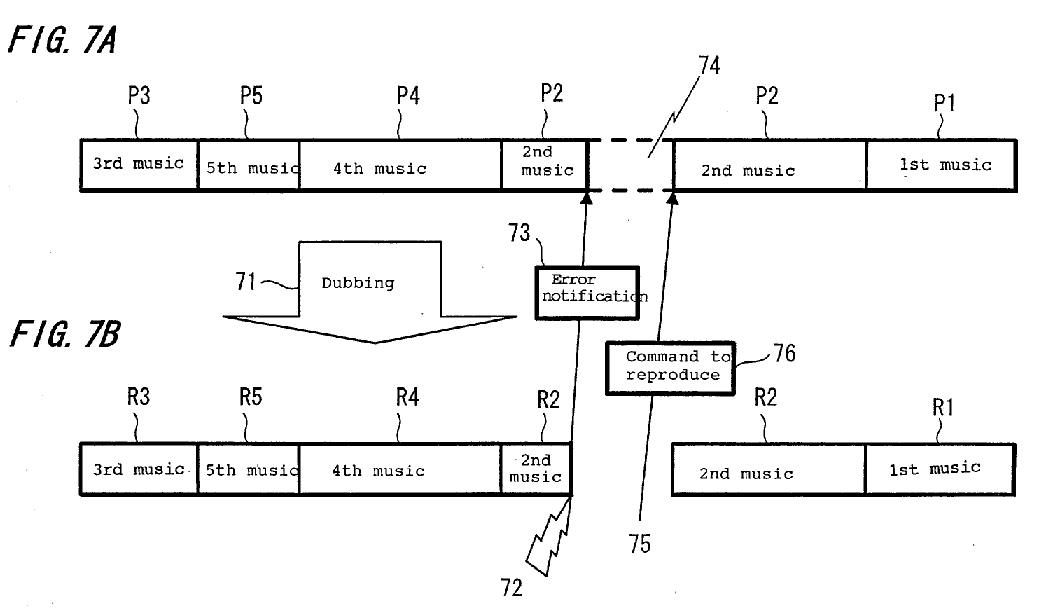

FIG. 7 shows such a status that the optical disc reproducing apparatus 1 reproduced music in the order programmed in advance, and a transfer error occurred in the middle of the 2nd music, and dubbing was performed in the magneto-optical disc recording/reproducing apparatus 2 from the start of the 2nd music.

In FIG. 7A, the optical disc reproducing apparatus 1 reproduced music in order of 3rd music (P3), 5th music (P5), 4th music (P4), and 2nd music (P2), and in FIG. 7B, a transfer error occurred in the middle of the 2nd music when dubbing 71 was being performed by the magneto-optical disc recording/reproducing apparatus 2 in order of 3rd music (R3), 5th music (R5), 4th music (R4), and 2nd music (R2).

At this time, the magneto-optical disc recording/reproducing apparatus 2 detects the error as indicated by 72, and notifies the error to the optical disc reproducing apparatus 1 as indicated by 73. Upon receiving the error information 73, the optical disc reproducing apparatus 1 is placed under a stop status 74 in the retry mode. The magneto-optical disc recording/reproducing apparatus 2 sends a reproducing command 76 to the optical disc reproducing apparatus 1 at the time 75 when a retry preparation is completed. Upon receiving the reproduction command 76, the optical disc reproducing apparatus 1 returns to the start of the 2nd music (P2) on which the error occurred and starts reproducing, and the magneto-optical disc recording/reproducing apparatus 2 starts recording from the start of the 2nd music (R2).

Thereafter, the optical disc reproducing apparatus 1 reproduces music in order of 2nd music (P2) and 1st music (P1), and the magneto-optical recording/reproducing apparatus 2 performs the dubbing 71 in order of 2nd music (R2) and 1st music (R1) as shown in FIG. 7B.

Next, a transfer error which causes the above described dubbing retry operations will be described in detail. The error in this case corresponds to a comparatively minor error which can be restored by a dubbing retry.

FIG. 8 is a flow chart showing an error detecting operation under a PLL unlocked condition. The controller 39 of the magneto-optical disc recording/reproducing apparatus 2 judges a PLL unlock condition by a value of [PLLUn-Lock] of a CFR (Configuration Register) provided within the IEEE 1394 interface circuit 47.

The controller 39 of the magneto-optical disc recording/reproducing apparatus 2 which is the receiving side of a data transfer through the IEEE 1394 bus 3 writes [PLLLock/Un-Lock] data which indicates a continuity or discontinuity of data to the CFR provided within the IEEE 1394 interface circuit 47. As for the [PLLLock/Un-Lock] data, [PLLLock] and [PLLUn-Lock] are expressed as [0] and [1] respectively.

Conditions at the time of [PLLUn-Lock] are as follows.

1st case: Preambles [B], [M], AND [W] could not be detected individually and two times continuously with the received data locked (PLLLock). Preamble codes (PAC) are [B]=[11], [M]=[01], and [W]=[00].

2nd case: Results of parity check on received data were continuously negative (NG) for three times.

3rd case: Preamble [B] did not come to 192th sample after the last preamble [B].

Further, the conditions at the time of [PLL-Lock] are the case where the conditions at the time of above described [PLLUn-Lock] were not satisfied in 512 samples (L/R channel set=One sample).

Referring to FIG. 8, it is decided if dubbing is being performed or not in step S1. Specifically, audio data reproduced by the optical disc reproducing apparatus 1 are transferred to the magneto-optical disc recording/reproducing apparatus 2 through the IEEE 1394 bus 3, and it is decided if the audio data are being dubbed recorded) by the magneto-optical disc recording/reproducing apparatus 2 or not.

When it is decided, in the step S1, that the audio data are being dubbed, the operation goes to step S2, and it is decided if the operation is under the condition of PLL Unlock or not. Specifically, the controller 39 of the magneto-optical disc recording/reproducing apparatus 2 judges the PLL Unlock condition by a value of [PLLUn-Lock] of the CFR provided within the IEEE 1394 interface circuit 47 based on the above described conditions.

When it is decided, in the step S2, that the operation is under the PLL Unlock condition, the operation goes to step S3, and error detection is performed. Specifically, the controller 39 of the magneto-optical disc recording/reproducing apparatus 2 is notified that an error occurred on the data transfer from the IEEE 1394 interface circuit 47 through the IEEE 1394 bus 3, stops the operation, and sends error notification to the controller 28 of the optical disc reproducing apparatus 1. The controller 28 of the optical disc reproducing apparatus 1 moves to the retry mode, and stops the operation. Upon receiving the error data, the optical disc reproducing apparatus 1 is placed under stop condition by the retry mode. Upon completion of retry preparation, the magneto-optical disc recording/reproducing apparatus 2 sends a reproducing command to the optical disc reproducing apparatus 1. Upon receiving the reproducing command, the optical disc reproducing apparatus 1, returns to the start of the music on which the error occurred and starts reproducing, and the magneto-optical disc recording/reproducing apparatus 2 executes a dubbing retry by starting to record the music from the start.

Further, the error detection for the dubbing retry operations may not be limited to this and may also be an error detection indicated in the followings.

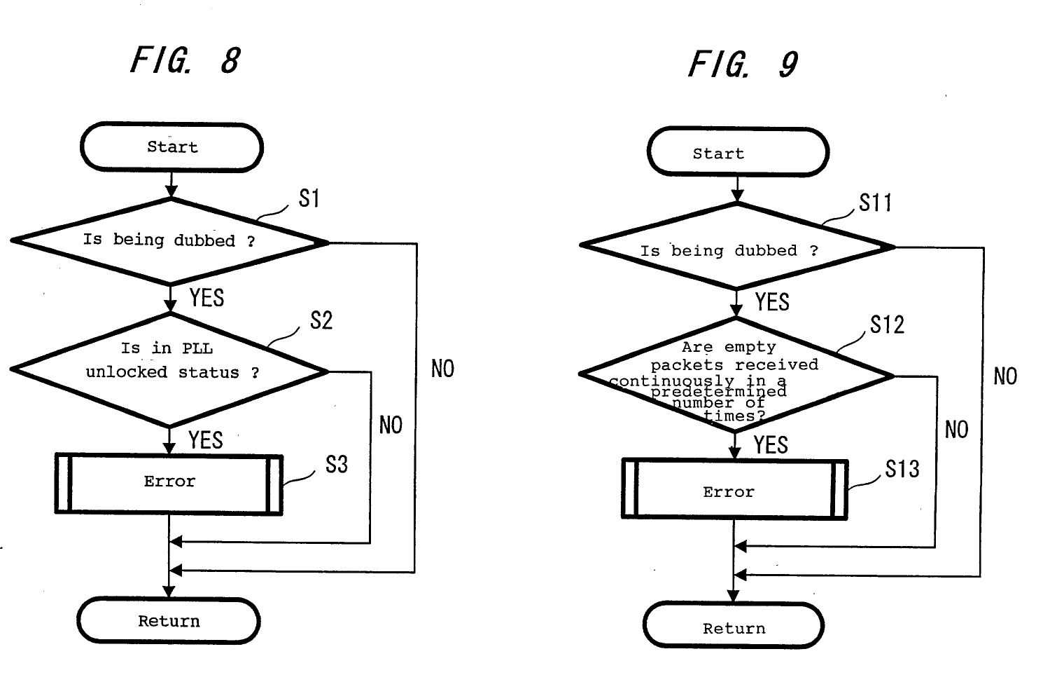

FIG. 9 is a flow chart showing an operation of detecting an error with the number of receipt of empty packets.

The controller 39 of the magneto-optical disc recording/reproducing apparatus 2 which is the receiving side of data transfer through the IEEE 1394 bus 3 supervises isochronous packets, and when the magneto-optical disc recording/reproducing apparatus 2 is receiving audio signals of the IEC 958 standard in AM824 format of audio and music data protocol and detects reception of empty packets (packets only consisted of header data) continuously in a predetermined number of times, the magneto-optical disc recording/reproducing apparatus 2 decides the number of empty packets receipt from the value of [IF Empty] (This indicates that Isochronous FIFO has become empty.) of an interrupt register provided on the CFR within the IEEE 1394 interface circuit 47.

Referring to FIG. 9, it is decided if a dubbing is being performed or not in step S11. Specifically, audio data reproduced by the optical disc reproducing apparatus 1 is transferred to the magneto-optical disc recording/reproducing apparatus 2 through the IEEE 1394 bus 3, and it is decided if the audio data is being dubbed (recorded) by the magneto-optical disc recording/reproducing apparatus 2 or not.

When it is decided, in the step S11, that the audio data is being dubbed, the operation goes to step S12, and it is decided if a specific number of empty packets are received continuously or not. Specifically, the controller 39 of the magneto-optical disc recording/reproducing apparatus 2 judges that the number of empty packet receipt is a specific number or more by the value of [IF Empty] of the interrupt register of the CFR provided within the IEEE 1394 interface circuit 47.

When it is decided, in step S12, that the specific number of empty packets are received continuously, the operations goes to step S13, and error detection is performed. Specifically, the controller 39 of the magneto-optical disc recording/reproducing apparatus 2 is notified that an error occurred on the data transfer from the IEEE 1394 interface circuit 47 through the IEEE 1394 bus 3, stops the operation, and sends an error data to the controller 28 of the optical disc reproducing apparatus 1. The controller 28 of the optical disc reproducing apparatus 1 moves to the retry mode, and stops the operation. Upon receiving the error data, the optical disc reproducing apparatus 1 is placed under the stop status by the retry mode. The magneto-optical disc recording/reproducing apparatus 2 sends, upon completion of retry preparation, a reproducing command to the optical disc reproducing apparatus 1. The optical disc reproducing apparatus 1, upon reception of the reproducing command, returns to the start of the music on which the error occurred and starts reproducing, and the magneto-optical disc recording/reproducing system 2 executes a dubbing retry by starting to record the music from the start.

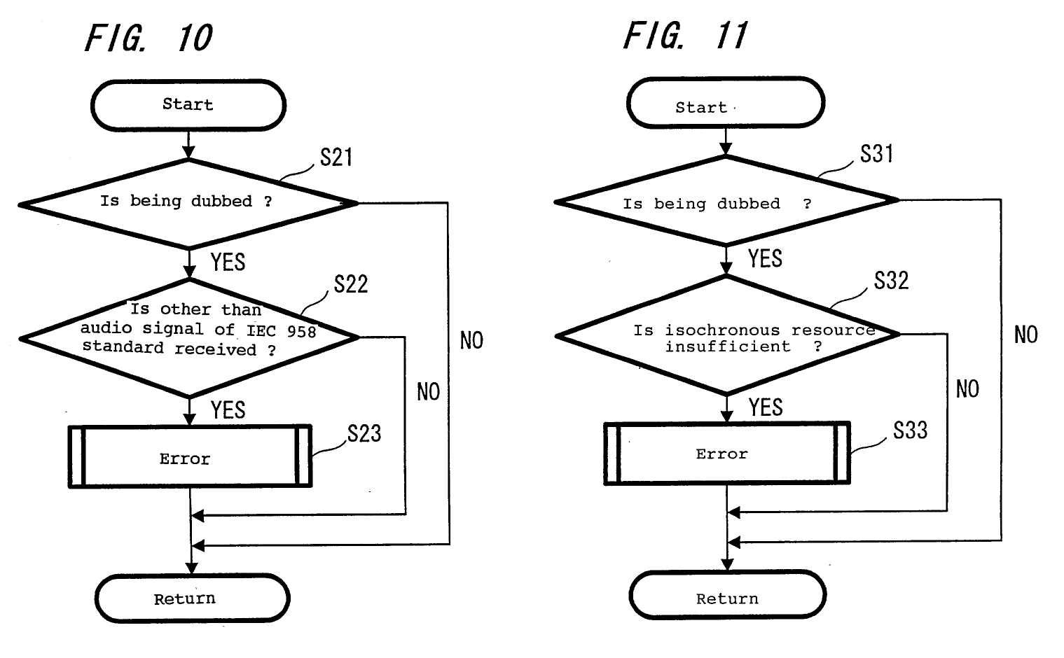

FIG. 10 is a flow chart showing an operation of detecting an error with a receipt of audio signals other than that of the IEC 958 standard.

The controller 39 of the magneto-optical disc recording/reproducing apparatus 2 which is the receiving side of data transfer through the IEEE 1394 bus 3 supervises isochronous packets, and it can be decided that audio signals of the IEC 958 standard are being received when data of labels in AM824 format of Audio and Music Data protocol are [00] to [3f].

Referring to FIG. 10, it is decided if a dubbing is being performed or not in step S21. Specifically, audio data reproduced by the optical disc reproducing apparatus 1 is transferred to the magneto-optical disc recording/reproducing apparatus 2 through the IEEE 1394 bus 3, and it is decided if the audio data is being dubbed (recorded) by the magneto-optical disc recording/reproducing apparatus 2 or not.

When it is decided, in the step S21, that the audio data is being dubbed, the operation goes to step S22, and it is decided if audio signals other than those of the IEC 958 standard are received or not. Specifically, the controller 39 of the magneto-optical disc recording/reproducing apparatus 2 decides that audio signals of the IEC 958 standard are received, when the data of labels in AM 824 format received in the buffer within the IEEE 1394 interface circuit 47 are [00] to [3f], and that audio signals other than the IEC 958 standards are received, when the data of labels in AM 824 format are other than [00] to [3f].

When audio signals other than those of the IEC 958 standard are received in the step S22, the operation goes to step S23, and error detection is performed. Specifically, the controller 39 of the magneto-optical disc recording/reproducing apparatus 2 is notified that an error occurred on data transfer from the IEEE 1394 interface circuit 47 through the IEEE 1394 bus 3, stops the operation, and sends error data to the controller 28 of the optical disc reproducing apparatus 1. The controller 28 of the optical disc reproducing apparatus 1 moves to the retry mode, and stops the operation. Upon receiving the error data, the optical disc reproducing apparatus 1 is placed under the stop status by the retry mode. The magneto-optical disc recording/reproducing apparatus 2 sends, upon completion of retry preparation, a reproducing command to the optical disc reproducing apparatus 1. The optical disc reproducing apparatus 1, upon receiving the reproducing command, returns to the start of the music on which the error occurred and starts reproducing, and the magneto-optical disc recording/reproducing apparatus 2 executes a dubbing retry by starting to record the music from the start.

Next, even when a transfer error is detected, a case where dubbing is canceled without executing the above described dubbing retry will be described. The error in this case corresponds to a comparatively serious error which cannot be restored by a dubbing retry.

FIG. 11 is a flow chart showing an operation of detecting an error with an insufficiency of isochronous resource.

The controller 39 of the magneto-optical disc recording/reproducing apparatus 2 which is the receiving side of a data transfer through the IEEE 1394 bus 3 must acquire an isochronous channel and bandwidth from an IRM (Isochronous Resource Manager), when performing isochronous transfer. However, when the isochronous channel required for the transfer cannot be acquired from the value of [CHANNELS AVAILABLE] into which the channel to be used by the CSR (Control and Status Register) is written, and the bandwidth required for the transfer cannot be acquired from the value of [BANDWIDTH AVAILABLE] into which the remaining bandwidth is written, it can be decided that the data cannot be transferred.

Referring to FIG. 11, it is decided if a dubbing is being performed or not in step S31. Specifically, the audio data reproduced by the optical disc reproducing apparatus 1 is transferred to the magneto-optical disc recording/reproducing apparatus 2 through the IEEE 1394 bus 3, and it is decided if the audio data is being dubbed (recorded) by the magneto-optical disc recording/reproducing system 2 or not.

When it is decided, in the step S31, that the audio data is being dubbed, the operation goes to step S32, and it is decided if the isochronous resource is insufficient or not. Specifically, the controller 39 of the magneto-optical disc recording/reproducing apparatus 2 decides that the data cannot be transferred when the isochronous channel required for the transfer cannot be acquired from the value of [CHANNELS AVAILABLE] of the CSR within the IEEE 1394 interface circuit 47 and when the bandwidth required for the transfer cannot be acquired from the value of [BANDWIDTH AVAILABLE].

When it is decided, in the step S32, that the isochronous resource is insufficient, the operation goes to step S33, and error detection is performed. Specifically, the controller 39 of the magneto-optical disc recording/reproducing apparatus 2 is notified that an error occurred on the data transfer from the IEEE 1394 interface circuit 47 through the IEEE 1394 bus 3, stops the operation, and sends an error notification to the controller 28 of the optical disc reproducing apparatus 1. The controller 28 of the optical disc reproducing apparatus 1 moves to the stop mode and stops the operation.

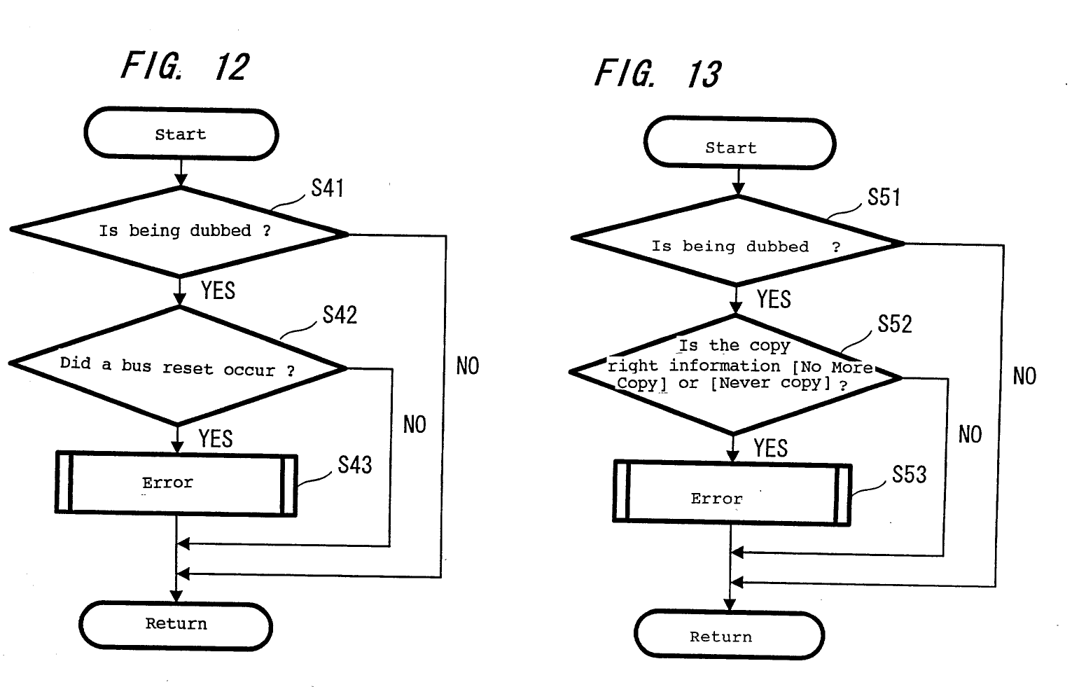

FIG. 12 is a flow chart showing an operation of detecting an error with an occurrence of bus reset.

When power source of a node is turned on or the node is connected to the bus, a bus reset occurs. When the bus reset occurs, a delay of isochronous service interval and a lack of cycle start packet occur, causing noise and the like on data transfer.

The controller 39 of the magneto-optical disc recording/reproducing apparatus 2 which is the receiving side of a data transfer through the IEEE 1394 bus 3 can decide from the value of [Buss Rst] of the interrupt register provided on the CFR within the IEEE 1394 interface circuit 47, that an error occurred as the bus reset occurred.

Referring to FIG. 12, it is decided if a dubbing is being performed or not in step S41. Specifically, audio data reproduced by the optical disc reproducing apparatus 1 are transferred to the magneto-optical disc recording/reproducing apparatus 2 through the IEEE 1394 bus 3, and it is decided if the audio data is being dubbed (recorded) by the magneto-optical disc recording/reproducing apparatus 2 or not.

When it is decided, in the step S41, that the audio data is being dubbed, the operation goes to step S42, and it is decided if a bus reset occurred or not. Specifically, the controller 39 of the magneto-optical disc recording/reproducing apparatus 2 decides from the value of [Buss Rst] of the interrupt register provided on the CFR within the IEEE 1394 interface circuit 47, that an error occurred as the bus reset occurred.

When it is decided, in the step S42, that the bus reset occurred, the operation goes to step S43, and error detection is performed. Specifically, the controller 39 of the magneto-optical disc recording/reproducing apparatus 2 is notified that an error occurred on the data transfer from the IEEE 1394 interface circuit 47 through the IEEE 1394 bus 3, stops the operation, and sends an error notification to the controller 28 of the optical disc reproducing apparatus 1. The controller 28 of the optical disc reproducing apparatus 1 moves to the stop mode and stops the operation.

FIG. 13 is a flow chart showing an operation of detecting an error with a reproduction prohibited copy right data.

The controller 39 of the magneto-optical disc recording/reproducing apparatus 2 which is the receiving side of a data transfer through the IEEE 1394 bus 3 can decide that the data reproduced by the optical disc reproducing apparatus 1 is not allowed to record by the magneto-optical disc recording/reproducing apparatus 2 when copy right information of the data received in the buffer within the IEEE 1394 interface circuit 47 is [No More Copy] or [Never Copy] which indicates a prohibition of duplication.

Referring to FIG. 13, it is decided if a dubbing is being performed or not in step S51. Specifically, the audio data reproduced by the optical disc reproducing apparatus 1 is transferred to the magneto-optical disc recording/reproducing apparatus 2 through the IEEE 1394 bus 3, and it is decided if the audio data are dubbed (recorded) by the magneto-optical disc recording/reproducing apparatus 2 or not.

When it is decided, in the step S51, that the audio data are being dubbed, the operation goes to step S52, and it is decided if the data are reproduction prohibited copy right data or not. Specifically, the controller 39 of the magneto-optical disc recording/reproducing apparatus 2 judges that an error occurred, when copy right information of the data received in the buffer within the IEEE 1394 interface circuit 47 is [No More Copy] or [Never Copy] which indicates a prohibition of duplication.

When it is decided, in the step S52, that the copy right information is of a prohibition of duplication, the operation goes to step S53, and error detection is performed. Specifically, the controller 39 of the magneto-optical disc recording/reproducing apparatus 2 is notified that an error occurred on the data transfer from the IEEE 1394 interface circuit 47 through the IEEE 1394 bus 3, stops the operation, and sends the error notification to the controller 28 of the optical disc reproducing apparatus 1. The controller 28 of the optical disc reproducing apparatus 1 moves to the stop mode and stops the operation.

Conventionally, in a dubbing (recording) from an optical disc reproducing apparatus to a magneto-optical disc recording/reproducing apparatus, such a factor from which occurrence of noise due to dust and scratch stuck on an optical disc and vibration and discontinuity of reproduced audio signals could be detected was supervised while reading out music data from recording media, and dubbing (recording) was tried again by changing conditions of the dubbing (recording) or by other means, when noise or discontinuity of reproduced audio signal occurred, however, according to the preferred embodiment, dubbing can be tried again or canceled with not only the above described error at the time of reproducing, but also with an error occurred during a data transfer.

As a result, quality of dubbed (recorded) data is improved by detecting an error due to a data transfer and by retrying a dubbing (recording) with distinguishing factors in errors due to data transfer and by deciding correct error factors, and quality of dubbed (recorded) data can be further improved by deciding exact error factors, while making a decision by combining the error factor due to data transfer with the error factors at the time of reproducing.

Thus, sound quality of dubbed (recorded) data can be further improved by simultaneously supervising a plurality of error items at the time of transfer and by restarting the dubbing (recording) when it is decided that noise or discontinuity of reproduced audio signals due to an error occurred. As a result, users can perform dubbing (recording) in further excellent audio quality without checking by reproducing recorded data.

Moreover, in the above described preferred embodiment, only the IEEE 1394 standard in which transfer errors occurred was indicated as an interface unit, however, needless to say, it can be applied to other interfaces, for example, USB (Universal Serial Bus) and the like.

The recording apparatus of the present invention is a recording apparatus that dubs data in a predetermined format transferred by an interface unit and reproduced by a reproducing unit, comprising transfer error detection means that detects an error on data transfer occurred in the interface unit, transfer error notification means that notifies the transfer error to the reproducing unit, recording retry preparation means that stops the data transfer based on the error notification after returning back to the start of the track of the data in which the transfer error occurred, and retry means that sends a command to reproduce to the reproducing unit after completing preparation of the recording retry and retries dubbing, and therefore, there is such effect that quality of data dubbed (recorded) can be improved by restarting recording for dubbing even when a data transfer error occurs in the interface unit.

Further, the reproducing apparatus of the present invention is a reproducing apparatus that transfers data reproduced by the interface unit in a predetermined format to the recording unit, and reproduces data to dub the data in the recording unit, comprising transfer error receiving means that receives a data transfer error notification in the interface unit detected by the recording unit, reproducing retry preparation means that stops operation based on the error notification after returning back to the start of the track of the data on which the transfer error occurred, and retry means that receives a command to reproduce from the recording unit after completing preparation of the reproducing retry, retries dubbing, and therefore, there is such effect that quality of data dubbed (recorded) can be improved by restarting reproducing for dubbing even when a data transfer error occurs in the interface unit.

The recording/reproducing system of the present invention is a recording/reproducing system that dubs data by employing a reproducing unit that reproduces data, a recording unit that records the reproduced data, and an interface unit that transfers data in a predetermined format between the reproducing unit and recording unit, comprising transfer error detection means that detects a data transfer error in the interface unit, transfer error notification means that notifies the transfer error from the recording unit to the reproducing unit, reproducing retry preparation means that causes the reproducing unit to stop based on the error notification after returning back to the start of the track of the data on which the transfer error occurred, recording retry preparation means that causes the recording unit to stop based on the error notification after returning back to the start of the track of the data on which the transfer error occurred, and retry means that sends a command to reproduce from the recording unit to the reproducing unit after completing reproducing retry preparation at the reproducing unit and recording retry preparation at the recording unit and retries dubbing, and therefore, there is such effect that quality of data recorded for dubbing can be improved by restarting dubbing even when a data transfer error occurs in the interface unit.

Further the recording/reproducing system of the present invention, as described above, sends conditions at the time of a retry mode by the retry means before completing the reproducing retry preparation in the reproducing unit and completing the recording retry preparation in the recording unit, and therefore, there is such effect that a precise retry can be executed by setting conditions at the time of retry for a data transfer error in the interface unit.

Further, the recording/reproducing system of the present invention, as described above, has such effect that discontinuity of transferred data can be solved by retrying dubbing (recording) with detecting discontinuity of transferred data, as the transfer error is due to discontinuity of transfer data.

Further, the recording/reproducing system of the present invention, as described above, has such effect that only audio signals in a predetermined format can be dubbed (recorded) by retrying dubbing (recording) with detecting that the audio signal in the predetermined format is not received, as the transfer error is due to not receiving the audio signal of the predetermined format.

Further, the recording/reproducing system of the present invention, as described above, has such effect that a dubbing (recording) in which empty packets do not continue can be performed by retrying dubbing (recording) with detecting that receipt of empty packet continued for a predetermined number of times, as the transfer error is due to the receipt of empty packets continued for the predetermined number of times when receiving audio signals in a predetermined format.

Further, in a recording/reproducing apparatus that dubs data by employing a reproducing unit that reproduces data, recording unit that records the reproduced data, and interface unit that transfers data in a predetermined format between the reproducing unit and recording unit, the recording/reproducing system of the present invention has such an advantage that deterioration of dubbed (recorded) recording data can be prevented by stopping the dubbing even if a data transfer error occurs in the interface unit, as this recording/reproducing apparatus is comprised of transfer error detection means that detects a data transfer error in the interface unit and stop means that stops dubbing when a transfer error is detected during a dubbing.

Further, the recording/reproducing system of the present invention, as described above, has such effect that a dubbing (recording) with an insufficiency of isochronous resource can be prevented by stopping the dubbing (recording) when it is detected that isochronous resource was insufficient, as the transfer error occurs when isochronous resource is insufficient.

Further, the recording/reproducing system of the present invention, as described above, has such effect that noise due to a bus reset can be prevented by stopping the dubbing (recording) when it is detected that a bus reset occurred, as the transfer error is due to the occurrence of the bus reset.

Furthermore, the recording/reproducing system of the present invention, as described above, has such effect that a dubbing (recording) can be caused to stop when it is detected that the copy right information of the transferred data indicates prohibition of dubbing, as the transfer error is due to prohibition of dubbing by the copy right information of the transferred data.

### INDUSTRIAL APPLICABILITY

The present invention can be applied, for example, to a recording apparatus, reproducing apparatus, and recording/reproducing system that reproduce audio data recorded in an optical disc, and dub the reproduced audio data into a magneto-optical disc through an interface which is in conformity to the IEEE 1394 format. For example, the present invention can be applied to an audio system that performs so called dubbing in which audio data reproduced by a CD player is recorded into a mini disc (MD) by an MD recorder/player, and in this case, the CD player can be connected to the MD recording/player with an IEEE 1394 bus which is an interface in conformity to the IEEE 1394 format.

1. In a recording apparatus that records plurality of main data divided into each unit of data, reproduced by a reproducing apparatus, and sent through a network,
a recording apparatus comprising:
recording means for recording a main data sent from said reproducing apparatus into a recording medium;
communication means for communicating with said reproducing apparatus through said network;
detection means for detecting a communication error of said main data received by said communication means;
notification means that notifies occurrence of a communication error to said reproducing apparatus based on a detection result of communication error provided by said detection means; and
control means for controlling said recording means so that the recording is performed again from the start position where recording of the main data started when a communication error is detected by said detection means, and controlling said communication means in order to send reproducing start data to said reproducing means through said network so that the reproducing is started from the start position of the main data in which said communication error was detected.

2. The recording apparatus according to claim 1, wherein
said control means further controls said recording means so that said recording means starts recording said main data after receiving, from said reproducing apparatus, said main data of which reproducing was started from the starting position of the main data in which said communication error was detected.

3. The recording apparatus according to claim 1, further comprising
status detecting means that detects an operating status of said reproducing apparatus, wherein
said control means controls said communication means so that said reproducing start data is transmitted after detecting that the operating status of said reproducing apparatus is in a predetermined status by said status detection means after detecting said communication error.

4. In a reproducing apparatus that transmits main data reproduced from recording media by each unit of said main data to the recording apparatus connected through a network, a reproducing apparatus comprising:
reproducing means for reproducing predetermined main data from said recording media;
communication means for communicating with said recording apparatus through a network;
detection means for detecting error signals detected in said recording apparatus and received by said communicating means; and
control means for controlling said reproducing means so that, when said detection means detects error signals, reproducing starts from reproducing start position of the main data in which an error detected by said recording apparatus.

5. The reproducing apparatus according to claim 4, wherein said control means suspends reproducing of main data from said reproducing means until an instruction to restart reproducing is received from said recording apparatus through said network.

6. The reproducing apparatus according to claim 4, wherein said control means controls said communication means so that an operating status of said reproducing apparatus is sent to said recording apparatus through said network when a request for transmission of the operating status of said reproducing apparatus is received from said recording apparatus.

7. In a recording/reproducing system that performs dubbing data by employing a reproducing unit that reproduces data, recording unit that records the reproduced data, and interface unit that transfers data in a predetermined format between said reproducing unit and said recording unit,
a recording/reproducing system comprising:
transfer error detection means for detecting a transfer error of data in said interface unit;
transfer error notification means for notifying said transfer error from said recording unit to said reproducing unit;
reproducing retry preparation means for causing said reproducing unit to stop based on said error information after returning to the start of track of data on which said transfer error occurred;
recording retry preparation means for causing said recording unit to stop based on said error information after returning to the start of track of data on which said transfer error occurred; and
retry means for sending a command to reproduce from said recording unit to said reproducing unit after completing said reproducing retry preparation in said reproducing unit and said recording retry preparation in said recording unit, wherein said retry of dubbing is performed.

8. The recording/reproducing system according to claim 7, wherein
conditions at the time of retry performed by said retry means are sent from said reproducing unit to said recording unit before completing said reproducing retry preparation in said reproducing unit and said recording retry preparation in said recording unit.

9. The recording/reproducing system according to claim 7, wherein
said transfer error is due to detection of discontinuity of transferred data.

10. The recording/reproducing system according to claim 7, wherein
said transfer error is due to not receiving audio signals in predetermined format.

11. The recording/reproducing system according to claim 7, wherein
said transfer error is due to reception of empty packets continued for a predetermined number of times when receiving audio signals in predetermined format.

12. In a recording/reproducing system that performs dubbing by employing a reproducing unit that reproduces data, recording unit that records the reproduced data, and interface unit that transfers data in a predetermined format between said reproducing unit and said recording unit, a recording/reproducing system comprising:
transfer error detection means for detecting transfer error of data in said interface unit; and
suspension means for stopping said dubbing when said transfer error is detected during said dubbing.

13. The recording/reproducing system according to claim 12, wherein
said transfer error is due to insufficiency of isochronous resource.

14. The recording/reproducing system according to claim 12, wherein
said transfer error is due to occurrence of bus reset.

15. The recording/reproducing system according to claim 12, wherein
said transfer error is due to the fact that the copy right information of said transferred data is of a data that prohibits said dubbing.

16. In a recording method for recording plurality of main data reproduced by a reproducing apparatus after divided into each unit of the data into recording media and sent through a network,
a recording method comprising:
a receiving step of receiving main data sent from said reproducing apparatus;
a detection step of detecting an error of said received main data;
a recording step of recording said main data into said recording media when no error is detected on said received data;
a notification step of notifying that an error is detected to said reproducing apparatus when an error is detected in said received main data; and
a standby step of standing by at the start position of recording of the main data on which said error was detected, for starting reproducing of the main data on which said error was detected from the start position of the reproducing in said reproducing apparatus.

17. The recording method according to claim 16, further comprising
a transmitting step of transmitting an instruction to start reproducing to said reproducing apparatus so that the reproducing is started from the start position where reproducing of the main data on which said error was detected is started, when standing by for starting of the reproducing apparatus.

18. In a reproducing method for transmitting main data reproduced from recording media by dividing the data into each unit to a recording apparatus through a network,
a reproducing method comprising:
a detection step of transmitting main data reproduced from said recording media by dividing said main data into each unit to said recording apparatus, and detecting an error notification signal sent from said recording apparatus; and
a standby step of standing by for a restart of reproducing so that the reproducing is restarted from the position where the reproducing of main data on which an error was detected by said recording apparatus is started, when it is detected that an error notification signal was sent from said recording apparatus.

19. The reproducing method according to claim 18, further comprising
a step of starting reproducing from the start position of main data that is standing by for said reproducing when a reproducing start command sent from said recording apparatus is received while standing by for a restart of said reproducing.
